(19) United States
(12) Patent Application Publication
(10) Pub. No.: US 2016/0050591 A1
(43) Pub. Date: Feb. 18, 2016

(54) METHOD AND NETWORK NODE FOR ENABLING AN EXTENDED A BASE STATION IDENTITY

(71) Applicant: TELEFONAKTIEBOLAGET L M ERICSSON (PUBL), Stockholm (SE)

(72) Inventor: Martin ISRAELSSON, Spånga (SE)

(21) Appl. No.: 14/779,239

(22) PCT Filed: Jan. 27, 2014
(86) PCT No.: PCT/SE2014/050097

§ 371 Date: Sep. 22, 2015

Related U.S. Application Data
(60) Provisional application No. 61/804,791, filed on Mar. 25, 2013.

(51) Int. Cl. H04W 36/00; H04W 36/08

(52) U.S. Cl. CPC H04W 36/0061; H04W 36/08; H04W 84/042

(57) ABSTRACT

A method in a first network node for sending a message to a second network node or receiving the message from the second network node is provided. The first network node sends (302) the message to the second network node, or receives the message from the second network node. The message relates to the base station serving the cell. The message comprises a part of a Cell Identity Information Element (IE), relating to the cell. The part of the Cell Identity IE comprises two parts, a base station identity part for an identity of the base station, and a cell identity part for an identity of the cell. One or more bits of the cell identity part a reused for the base station identity part, such that the base station identity part is extended. The extended base station identity part is filled up with an extended identity of the base station.

### TECHNICAL FIELD

Embodiments herein relate to a first network node and a method therein. In particular it relates to sending a message to a second network node, which message relates to a base station.

### BACKGROUND

Communication devices such as terminals are also known as e.g. User Equipments (UE), mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for terminals. The 3GPP has undertaken to evolve further the UTRAN and GSM based radio access network technologies.

3GPP LTE radio access standard has been written in order to support high bitrates and low latency both for uplink and downlink traffic. All data transmission is in LTE controlled by the radio base station.

Improved support for heterogeneous network operations is part of the ongoing specification of 3GPP LTE. In heterogeneous networks, a mixture of cells of differently sized and overlapping coverage areas are deployed. One example of such deployments is illustrated in FIG. 1 where pico cells 10 served by pico base stations 15 also referred to as pico eNBs are deployed within the coverage area of a macro cell 20 served by a macro base stations 25 also referred to as macro eNBs.

The aim of deploying low power nodes such as pico base stations within the macro coverage area of the macro cell is to improve system capacity by means of cell splitting gains as well as to provide users with wide area experience of very high speed data access throughout the network. Heterogeneous deployments are in particular effective to cover traffic hotspots, i.e. small geographical areas with high user densities served by e.g. pico cells, and they represent an alternative deployment to denser macro networks.

There is currently an upper limit in the number of base stations also referred to as eNBs that can be uniquely defined in an operators network such as Public Land Mobile Network (PLMN), and with the foreseen densification the current upper limit may be to small for some large countries.

A Global eNB ID defined to uniquely define a base station such as an eNB within an operator's network such as Public Land Mobile Network (PLMN) is defined in 3GPP TS 36.413 section 9.2.1.37, and TS 36.423 section 9.2.22. For a macro eNB the Global eNB ID is defined as a PLMN Identity followed by the 20 leftmost bits of a Cell Identity, i.e. a part of a Cell Identity comprised in an Evolved Universal Mobile Telecommunications System Terrestrial Radio Access Network (E-UTRAN) Cell Global identity (CGI) IE. This will give the upper limit of 2̂20=1048575 eNBs in one PLMN.

The size of the Cell Identity cannot be changed without affecting existing UE's, since the Cell Identity is visible for the UE. The Cell Identity is broadcasted by the cell and UE's read it to identify the cell, and if the size of the broadcasted Cell Identity would change the existing UE's would not be able to read and understand it. As described in 3GPP TS 36.413 section 9.2.1.38, TS 36.423 section 9.2.14 and TS 36.331 section 6.3.4, the Cell Identity is defined as a bit string of 28 bits.

If more than 2̂20=1048575 eNBs needs to be deployed in an operators network, such as the PLMN, one possibility would be to re-use the Global eNB ID in different parts or regions of the operator's network. With this solution the identity of an eNB would however not be unique within the PLMN, so other means would have to be used to ensure the uniqueness, such as the region the eNB is deployed in.

Another potential solution would be to split the operator network such as the PLMN into two different PLMN's, but this may not the preferred solution for an operator.

### SUMMARY

It is therefore an object of embodiments herein to provide a way of improving system capacity in a wireless communications network.

According to a first aspect of embodiments herein, the object is achieved by a method in a first network node for sending a message to a second network node or receiving the message from the second network node.

The first network node sends the message to the second network node, or receives the message from the second network node. The message relates to a base station serving a cell.

The message comprises a part of a Cell Identity Information Element, IE, relating to the cell. The part of the Cell Identity IE comprises two parts, a base station identity part for an identity of the base station, and a cell identity part for an identity of the cell. One or more bits of the cell identity part are used for the base station identity part, such that the base station identity part is extended. The extended base station identity part is filled up with an extended identity of the base station.

According to a second aspect of embodiments herein, the object is achieved by a first network node for sending a message to a second network node or receiving the message from the second network node. The first network node comprises a sending and receiving circuit configured to send the message to or receive the message from the second network node. The message relates to the base station serving the cell. The message comprises a part of a Cell Identity Information Element, IE, relating to the cell. The part of the Cell Identity IE comprises two parts, a base station identity part for an identity of the base station, and a cell identity part for an identity of the cell.

One or more bits of the cell identity part are used for the base station identity part, such that the base station identity part is extended. The extended base station identity part is filled up with an extended identity of the base station.

Since one or more bits of the cell identity part is used for the base station identity part, such that the base station identity part is extended, the extended base station identity part can be filled up with an extended identity of the base station.

As mentioned above, the overall size of the Cell Identity IE cannot be changed. However, in this way, the border between the base station identity part and the cell identity part is shifted within the Cell Identity IE, and thus the number of bits used for the base station identity part is increased at the expense of the bits used for the cell identity part. This does not affect any UE's since the overall size of the Cell Identity does not change. Thus, an advantage with embodiments herein is that they allow expansion of the upper amount of eNBs in a wireless communications network, such as a PLMN, without any UE impact. In this way the system capacity in a wireless communications network has been improved.

### BRIEF DESCRIPTION OF THE DRAWINGS

Examples of embodiments herein are described in more detail with reference to attached drawings in which:

FIG. 1 is a schematic block diagram illustrating a wireless communications network according to prior art.

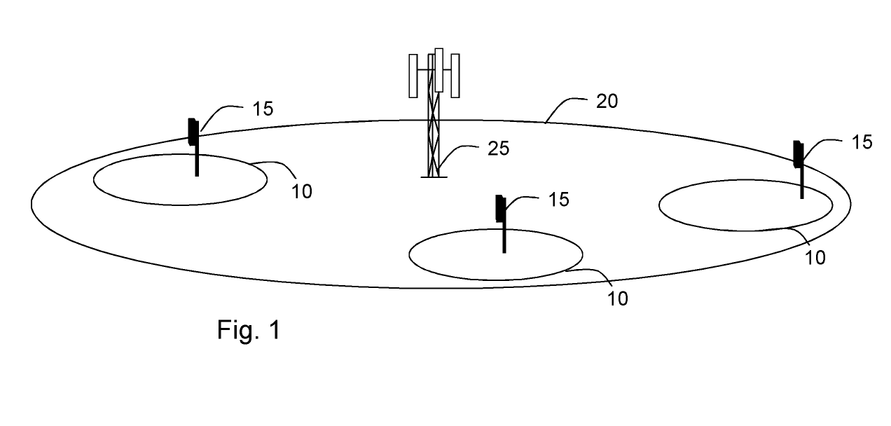

FIG. 2 is a schematic block diagram illustrating embodiments of a wireless communications network.

FIG. 3 is a flowchart depicting embodiments of a method in a network node.

FIG. 4 is a signalling scheme depicting embodiments of a method in a network node.

FIG. 5 is a signalling scheme depicting embodiments of a method in a network node.

FIG. 6 is a schematic block diagram illustrating embodiments of a network node

### DETAILED DESCRIPTION

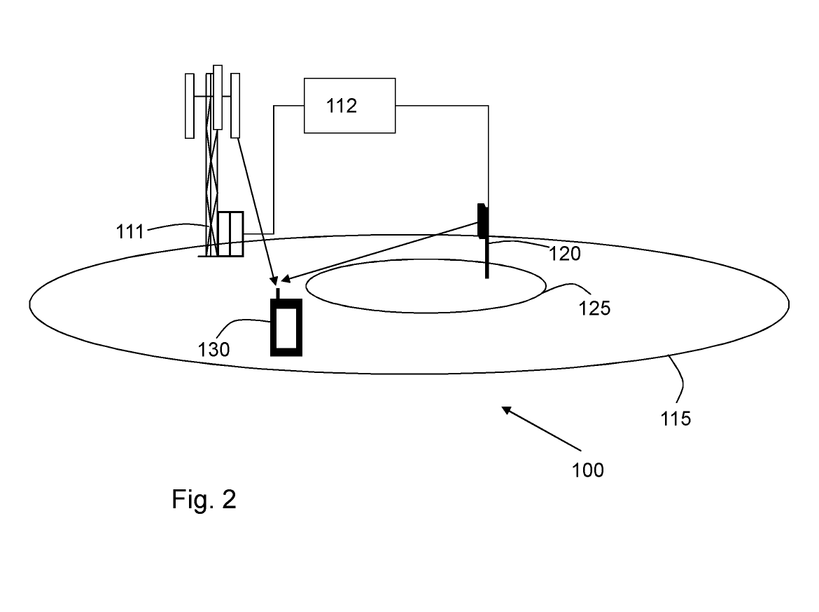

FIG. 2 depicts an example of a wireless communications network 100 in which embodiments herein may be implemented. The wireless communications network 100 is a wireless communication network such as an E-UTRAN, an UTRAN LTE, a WCDMA, a GSM network, any 3GPP cellular network, Wimax, or any cellular network or system in e.g. a PLMN.

The wireless communications network 100 comprises a first network node 111 and a second network node 112. The first network node 111 and the second network node 112 may each be a transmission point such as a radio base station, for example an eNB, an eNodeB, a macro eNB or an Home Node B, an Home eNode B or any other network node capable to serve a UE or a machine type communication device in a wireless communications network. The first network node 111 and the second network node 112 may each be for example a Mobility Management Entity (MME), Serving GPRS Support Node (SGSN), a Gateway GPRS Support Node, (GGSN), or a Mobile Switching Centre (MSC). This means that according to embodiments herein, the first network node 111 may for example be anyone out of: a base station, e.g. a pico base station or a macro base station, an MME, a SGSN, a GGSN, and a MSC.

For example, the first network node 111 may be a base station and the second network node 112 may be an MME, a SGSN, a GGSN, or a MSC, this is the scenario depicted in FIG. 2. When the first network node 111 may be a base station it serves one or more cells such as a cell 115.

In other embodiments, the first network node 111 may be an MME, a SGSN, a GGSN, or a MSC and the second network node 112 may be a base station, this scenario is not shown.

In further embodiments the first network node 111 may be a base station and the second network node 112 may be a base station, this scenario is not shown. Other scenarios are also possible.

The wireless communications network 100 further comprises a base station 120 serving one or more cells such as a cell 125. The base station 120 may in some embodiments be the first network node 111 or the second network node 112. The base station 120 may for example be an eNB, an eNodeB, or a Home Node B, and Home eNodeB, a pico eNB or any other network node capable to serve a UE or a machine type communication device in a wireless communications network. The base station 120 is also referred to as the eNB 120 in this document.

A UE 130 operates in the wireless communications network 100 and may be located in or may be moving towards the cell 125 served by the base station 120. The UE 130 may e.g. be a user equipment, a mobile terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network. Please note the term UE used in this document also covers other wireless devices such as Machine to machine (M2M) devices, even though they do not have any user.

Messages are e.g. transmitted between base stations over an X2 interface, or between a base station and a network node such as MME, a SGSN, a GGSN, or a MSC over an S1 interface.

Such a message comprises a Global eNB ID IE, relating to an eNB also referred to as a base station or network node such as the base station 120. The Global eNB ID IE is used to globally identify an eNB. The Global eNB ID IE comprises two parts, a PLMN Identity part for an identity of a PLMN, and an eNB ID part for an identity of an eNB such as the base station 120 within the PLMN. The eNB ID is based on a fixed size Cell Identity IE.

In fact the message comprises a Global eNB ID IE where the value is the same as the leftmost bits of the Cell Identity, which e.g. is broadcasted in the cell 125. This means that a part of the Cell Identity IE is comprised in the Global eNB ID IE of the message. The part of the Cell Identity IE in the message comprises two parts, a base station identity part for an identity of the base station 120, and a cell identity part for an identity of the cell 125.

The messages comprising the Global eNB ID are used in various signaling procedures in order to address a target eNB such as the base station 120 in S1 handover signalling procedures. Another example of a procedure is an S1 Setup Request procedure wherein the first network node 111 informs the second network node 112, such the MME of the Global eNB ID of the base station 120, so that the MME later can route for example Handover messages to the base station 120. A further example of procedure that makes use of the Global eNB ID is Configuration Transfer procedure wherein an eNB Configuration Transfer message is sent from the first network node 111 such as an eNB to the second network node 112, such the MME. Further, wherein, and MME sends a Configuration Transfer from a MME to a eNB.

The messages comprising the Global eNB ID may further be used in X2 signalling such as in an X2 Setup Request message and an X2 Setup Response message

The current Macro eNB ID is defined as the 20 leftmost bits of the Cell Identity. The wording “current Macro eNB ID” refers what is defined in the existing 3GPP specifications. This today enable an eNB to have 255 cells. As mentioned above, the overall size of the Cell Identity IE cannot be changed without impacting existing UE's. However, according to embodiments herein, the border between the bits of Macro eNB ID part such as the base station identity part, and the Cell ID part such as the cell identity part is shifted within the Cell Identity IE, i.e. the part of the Cell Identity IE comprised in the message, and thus the number of bits used for the Macro eNB ID at the expense of the bits used for the Cell ID within the Macro eNB ID are increased. This does not affect any UE's since the overall size of the Cell Identity does not change.

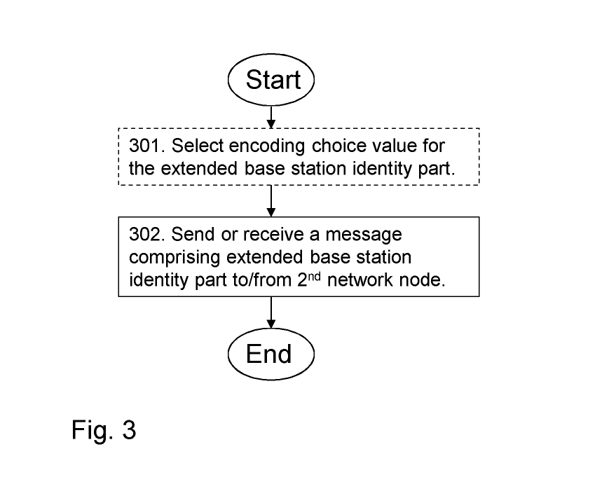

Example of embodiments of a method in the first network node 111 for sending a message to the second network node 112 or receiving the message from the second network node 112 will now be described with reference to a flowchart depicted in FIG. 3. As mentioned above, the first network node 111 may be a base station and the second network node 112 may be a base station. As an alternative, the first network node 111 may be a base station, and the second network node 112 may be any one out of: a Mobility Management Entity, MME, a Serving GPRS Support Node, SGSN, a Gateway GPRS Support Node, GGSN, or a Mobile Switching Centre, MSC. As a further alternative, the first network node 111 may be any one out of: a Mobility Management Entity, MME, a Serving GPRS Support Node, SGSN, a Gateway GPRS Support Node, GGSN, or a Mobile Switching Centre, MSC, and the second network node 112 may be a base station.

The method comprises the following actions, which actions may be taken in any suitable order. Dashed lines of a box in FIG. 3 indicate that this action is not mandatory.

Action 301

This action relates to embodiments wherein the message will be sent to the second network node 112.

Several new choice values, also referred to as encoding choices, i.e. the encoding option that are defined for the IE, may be added to enable a flexible selection (choice) of the number of bits used for the base station identity, such as the eNB ID. Thus, in these embodiments the first network node 111 may select an encoding choice value for the extended base station identity part among several encoding choices defined for the cell identity IE. This may be performed by selecting a number of bits to be used for the base station identity. For example it may have selected among a base station identity of 21-27 bits. This will be described more in detail below. The selected encoding choice value will be used in the message to be sent in Action 302.

Action 302

The first network node 111 sends the message to the second network node 112, or the first network node 111 receives the message from the second network node 112. The message relates to the base station 120 serving the cell 125.

The message comprises a part of a Cell Identity Information Element, IE, relating to the cell 125. The part of the Cell Identity IE comprises two parts, a base station identity part for an identity of the base station 120, and a cell identity part for an identity of the cell 125. According to embodiments herein, one or more bits of the cell identity part are used for the base station identity part, such that the base station identity part is extended.

The extended base station identity part is filled up with an extended identity of the base station 120. The extended base station identity part may comprise 1-7 bits of the cell identity part being added to the base station identity part. This means that the base station identity part may comprise a base station identity of more than 20 bits. For example, the base station identity part may comprise a base station identity of 21-27 bits. The number of bits used for the base station identity, may have selected by the first network node 111 in Action 301 above.

In some embodiments the part of the Cell Identity IE is comprised in a Global eNB ID Information Element of the message.

The message comprising the extended base station identity part, may e.g. be sent or received in any one out of: a configuration transfer procedure, and a S1 handover signalling procedure. These procedures will be described more in detail below. The message comprising the extended base station identity part, may e.g. also be sent or received in a S1 SETUP message.

An S1 Setup message is the first message that is sent by the eNB such as the first network node 111 over the S1 interface after the transport layer between the eNB and the MME has been established. The S1 Setup message will inform the MME such as the second network node 112 about the eNB such as the base station 120 and in particular it will inform the MME about the Global eNB ID which the MME needs to know about in order to route Handover messages to the particular eNB.

A change in 3GPP specifications enables the usage of more than 20 bits of the Cell Identity as the base station part such as the Macro eNB ID. According to embodiments herein, this is performed by adding one or several new choice values in the Global eNB ID in 3GPP Release 11 or later TS 36.413 and TS 36.423. Between 1 and 7 additional bits of the Cell Identity, i.e. the cell identity part may be used as part of the eNB ID, i.e. the base station identity part.

The example in the table below show an extension to enable the use of 24 bits for the Macro eNB ID, which extension scenario is underlined in the table. This would give the possibility to have 16777215 eNBs using a 24 bit eNB ID in the operator network, and still leave the possibility to have 16 cells in each eNB such as the base station 120.

Several new choice values, also referred to as encoding choices, i.e. the encoding option that are defined for the IE, may be added to enable a flexible selection (choice) of the number of bits used for the base station identity, such as the eNB ID. This relates to Action 301 above.

Table 1 is an example of 3GPP TS 36.413 table 9.2.1.37, Global eNB ID, wherein embodiments herein are comprised, marked by underlined text.

9.2.1.37 Global eNB ID

This information element is used to globally identify an eNB (see TS 36.401 [2]).

TABLE 1

| | | | IE type and | |
|---|---|---|---|---|
| IE/Group Name | Presence | Range | reference | Semantics description |
| PLMN Identity | M | | 9.2.3.8 | |
| CHOICE eNB ID | M | | | |
| >Macro eNB ID | | | | |
| >>Macro eNB ID | M | | BIT STRING (20) | Equal to the 20 leftmost bits of the |
| | | | | Cell Identity IE contained in the E- |
| | | | | UTRAN CGI IE (see subclause |
| | | | | 9.2.1.38) of each cell served by |
| | | | | the eNB. |
| >Home eNB ID | | | | |
| >>Home eNB ID | M | | BIT STRING (28) | Equal to the Cell Identity IE |
| | | | | contained in the E-UTRAN CGI IE |
| | | | | (see subclause 9.2.1.38) of the cell |
| | | | | served by the eNB. |
| >Macro 24 Bit eNB ID | | | | |
| >>Macro 24 Bit eNB | M | | BIT STRING (24) | Equal to the 24 leftmost bits of the |
| ID | | | | Cell Identity IE contained in the E- |
| (This row refers to | | | | UTRAN CGI IE (see subclause |
| the extended base | | | | 9.2.1.38) of each cell served by |
| station identity) | | | | the eNB. |

Table 2 below is an example of 3GPP TS 36.413 table 9.2.1.38, E-UTRAN CGI defining the Cell Identity IE.

9.2.1.38 E-UTRAN CGI

This information element is used to globally identify a cell (see TS 36.401 [2]).

TABLE 2

| IE/Group | | | IE type and | Semantics |
|---|---|---|---|---|
| Name | Presence | Range | reference | description |
| PLMN Identity | M | | 9.2.3.8 | |
| Cell Identity | M | | BIT | The leftmost bits of |
| | | | STRING | the Cell Identity |
| | | | (28) | correspond to the |
| | | | | eNB ID (defined in |
| | | | | subclause 9.2.1.37). |

In the Abstract Syntax Notation One (ASN.1) section 9.3.4 of 3GPP TS 36.413, wherein embodiments herein are comprised, see underlined text in the example below:

ENB-ID ::= CHOICE {

macroENB-ID BIT STRING (SIZE(20)),
homeENB-ID BIT STRING (SIZE(28)),
...,
macro24BitENB-ID BIT STRING (SIZE(24))
}

As mentioned above, the base station identity part may comprise a base station identity of more than 20 bits, e.g. 21-27 bits.

The “>Macro eNB ID”, “>Home eNB ID” and “>Macro 24 Bit eNB ID”, in the table above, represent different “choice tags”, i.e. they may be selected by the first network node 111. “Macro 24 Bit eNB ID”, refers to the extended base station identity, i.e. this example is extended with four bits. The “>>Macro eNB ID”, and the other starting with “>>”, in the Table 1 above, defines the encoding for the choices, showing for example that the Macro eNB ID is encoded as a bit string of 20 bits, and the Macro 24 Bit eNB ID is coded as a string of 24 bits.

Other options for an extended base station identity according to some embodiments herein may e.g. be:
Macro 21 Bit eNB ID coded as a string of 21 bits,
Macro 22 Bit eNB ID coded as a string of 22 bits,
Macro 23 Bit eNB ID coded as a string of 23 bits,
Macro 25 Bit eNB ID coded as a string of 25 bits,
Macro 26 Bit eNB ID coded as a string of 26 bits, and
Macro 27 Bit eNB ID coded as a string of 27 bits,

which all may be selected by the first network node 111 according to some embodiments herein. See Action 301.

Table 3 below is an example of 3GPP TS 36.423 Table 9.2.22, Global eNB ID, wherein embodiments herein are comprised, marked by underlined text. This IE is used to globally identify an eNB.

Note that Table 1 and Table 3 look the same, but they come from different specifications.

9.2.22 Global eNB ID

TABLE 3

| | | | IE type and | |
|---|---|---|---|---|
| IE/Group Name | Presence | Range | reference | Semantics description |
| PLMN Identity | M | | 9.2.4 | |
| CHOICE eNB ID | M | | | |
| >Macro eNB ID | M | | BIT STRING | Equal to the 20 leftmost bits of |
| | | | (20) | the value of the E-UTRAN Cell |
| | | | | Identifier IE contained in the |
| | | | | ECGI IE (see section 9.2.14) |
| | | | | identifying each cell controlled |
| | | | | by the eNB |
| >Home eNB ID | M | | BIT STRING | Equal to the value of the E- |
| | | | (28) | UTRAN Cell Identifier IE |
| | | | | contained in the ECGI IE (see |
| | | | | section 9.2.14) identifying the |
| | | | | cell controlled by the eNB |
| >Macro 24 Bit eNB ID | M | | BIT STRING | Equal to the 24 leftmost bits of |
| This row refers to | | | (24) | the value of the E-UTRAN Cell |
| the extended base | | | | Identifier IE contained in the |
| station identity | | | | ECGI IE (see section 9.2.14) |
| | | | | identifying each cell controlled |
| | | | | by the eNB |

In the ASN.1 section 9.3.5 of 3GPP TS 36.423, wherein embodiments herein are comprised, see underlined text:

ENB-ID ::= CHOICE {

macro-eNB-ID BIT STRING (SIZE (20)),
home-eNB-ID BIT STRING (SIZE (28)),
...,
Macro24bit-eNB-ID BIT STRING (SIZE (24))

}

The “>Macro eNB ID”, “>Home eNB ID” and “>Macro 24 Bit eNB ID” in the table above, represent different “choice tags”, i.e. they may be selected by the first network node 111. “Macro 24 Bit eNB ID”, refers to the extended base station identity according to embodiments herein. The “>>Macro eNB ID” and the other starting with “>>” in Table 3 above defines the encoding for the choices, showing for example that the Macro eNB ID is encoded as a bit string of 20 bits, and the Macro 24 Bit eNB ID is coded as a string of 24 bits.

Other options for an extended base station identity according to some embodiments herein may e.g. be:
Macro 21 Bit eNB ID coded as a string of 21 bits,
Macro 22 Bit eNB ID coded as a string of 22 bits,
Macro 23 Bit eNB ID coded as a string of 23 bits,
Macro 25 Bit eNB ID coded as a string of 25 bits,
Macro 26 Bit eNB ID coded as a string of 26 bits, and
Macro 27 Bit eNB ID coded as a string of 27 bits,

Which all may be selected by the first network node 111 according to some embodiments herein. See Action 301.

As mentioned above, the extended base station identity comprised in the cell identity IE such as the Global eNB ID, may be used in various signaling procedures in order to address a target eNB such as the base station 120. Examples of procedures that make use of the Global eNB ID are:
Configuration Transfer procedure, and
S1 Handover signaling procedure.

Configuration Transfer Procedure

This S1 interface procedure may for example be used by an eNB such as the first network node 111, to retrieve an X2 Transport Network Layer (TNL) address for another eNB such as the base station 120, to enable the establishment of an X2 connection between the two eNBs such as between the first network node 111 and the base station 120. I.e. in this scenario the first network node 111 is a base station such as an eNB.

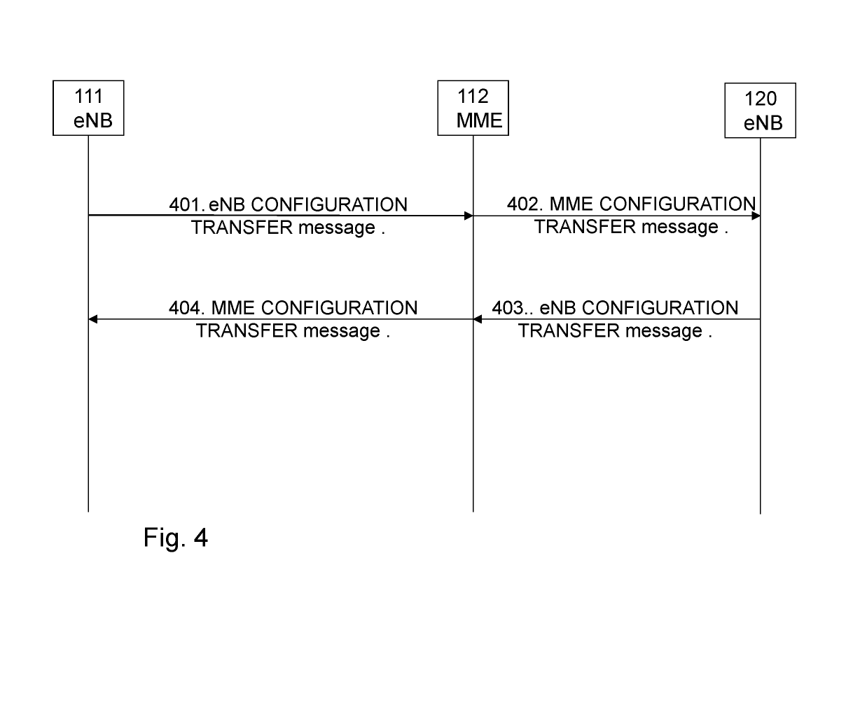

If the first network node 111, i.e. the eNB in this scenario is aware of the extended base station identity such as the extended eNB ID of the candidate eNB, i.e. the base station 120, e.g. via an Automatic Neighbour Relation (ANR) function, but does not know a TNL address suitable for Stream Control Transmission Protocol (SCTP) connectivity, then the first network node 111 may use the Configuration Transfer Function to determine the TNL address as follows. SCTP is a transport protocol that is used on the transport layers. This procedure is depicted in the signalling diagram in FIG. 4.

Action 401. The first base station 111, i.e. the eNB in this scenario sends an eNB CONFIGURATION TRANSFER message to the second network node 112, which in this scenario is an MME, to request the TNL address of the candidate eNB, i.e. the base station 120, and includes relevant information such as an extended source and target base station identity, e.g. an extended source and target eNB ID according to embodiments herein. This relates to a message according to Action 302 described above.

Action 402. The second network node 112, i.e. MME in this scenario, relays the request by sending the MME CONFIGURATION TRANSFER message to the base station 120, i.e. the candidate eNB, identified by the extended base station identity, i.e. the extended target eNB ID in this scenario according to embodiments herein.

Action 403. The base station 120, i.e. the candidate eNB responds to the second network node 112, i.e. the MME, by sending the eNB CONFIGURATION TRANSFER message comprising one or more TNL addresses to be used for SCTP connectivity with the initiating first network node, i.e. eNB, and includes other relevant information such as the extended source and target base station identity, e.g. the extended source and target eNB ID according to embodiments herein.

Action 404. The second network node 112, i.e. the MME relays the response by sending the MME CONFIGURATION TRANSFER message to the first network node 112, i.e. the initiating eNB identified by the extended base station identity, i.e. extended target eNB ID according to embodiments herein. Also this relates to a message according to Action 302 described above.

S1 Handover Signaling Procedure

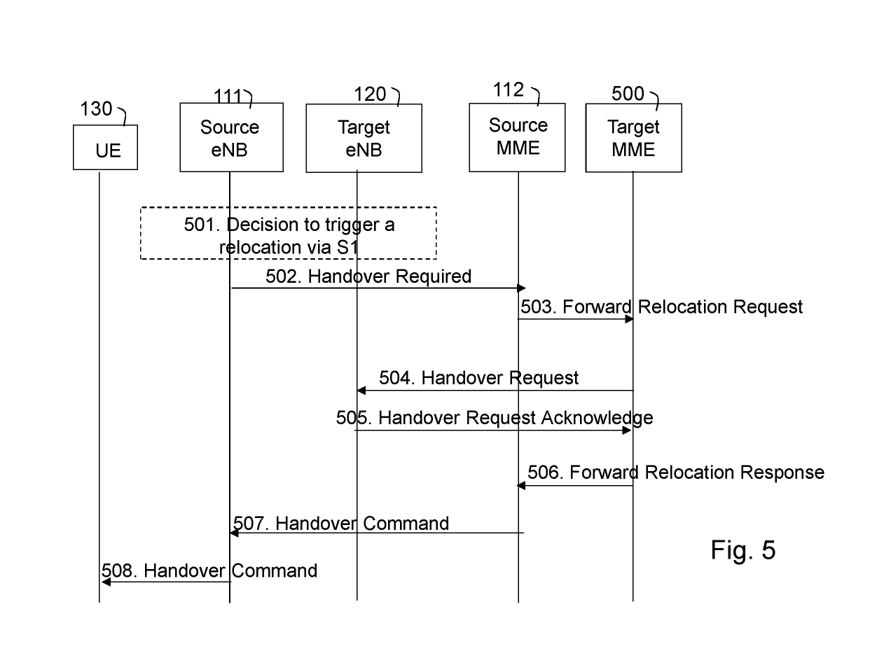

This procedure may be used in order to handover the UE 130 from the Source eNB, i.e. the first network node 111 in this scenario, to the Target eNB, i.e. the base station 120 in this scenario. This procedure is depicted in the signalling diagram in FIG. 5. In this scenario a target MME 500 is present.

Action 501. The source eNB, i.e. the first network node 111 decides to initiate an S1-based handover to the target eNodeB, i.e. the base station 120.

Action 502. The source eNodeB, i.e. the first network node 111 sends a Handover Required comprising the extended target eNodeB Identity, such as the extended base station identity according to embodiments herein, to the second network node 112 which in this case is a source MME. This is a message relating to Action 302 above.

Action 503. The second network node 112, i.e. the source MME selects the target MME 500 based on the extended target eNodeB Identity and it sends a Forward Relocation Request message comprising the extended base station identity such as a target eNodeB Identity according to embodiments herein, to the target MME 500.

Action 504. The Target MME 500 sends Handover Request message to the base station 120, i.e. the target eNodeB in this scenario.

Action 505. The base station 120, i.e. the target eNodeB sends a Handover Request Acknowledge message to the target MME 500.

Action 506. The target MME 500 sends a Forward Relocation Response message to the second network node 112, i.e. the source MME in this scenario.

Action 507. The second network node 112, i.e. source MME sends a Handover Command message to the first network node 111, i.e. the source eNodeB in this scenario.

Action 508. The Handover Command is constructed by the first network node 111, i.e. the source eNodeB and is sent to the UE 120.

The ASN.1 encoding choice for eNB-ID is extensible, as defined by an extension marker “ . . . ”). This enables that additional choice types, also referred to as choice value and choice encoding, and may be added in an updated version of the specifications. A receiving network node such as e.g. the first network node 111 or the second network node 112 that has been updated to support and understand the new choice type will be able to see from the ASN.1 encoding that the ASN.1 choice has been extended, and thus know how to decode the extended ENB-ID.

Before starting to use the extended eNB-ID in an area of the operator's network, it is preferable that all nodes in that area are updated to support the new choice encoding.

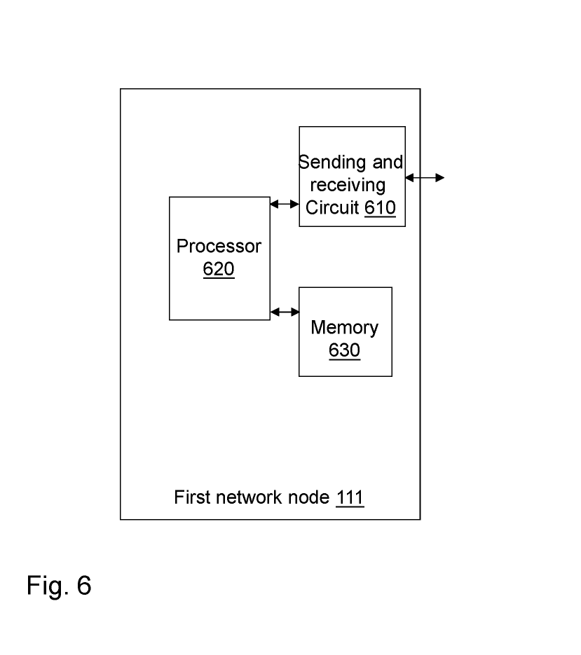

To perform the method actions for sending a message to a second network node 112) or receiving the message from the second network node 112, described above in relation to FIG. 3-5, the first network node 111 may comprise the following arrangement depicted in FIG. 6. As mentioned above, the first network node 111 may be a base station and the second network node 112 may be a base station. As an alternative, the first network node 111 may be a base station, and the second network node 112 may be any one out of: a Mobility Management Entity, MME, a Serving GPRS Support Node, SGSN, a Gateway GPRS Support Node, GGSN, or a Mobile Switching Centre, MSC. As a further alternative, the first network node 111 may be any one out of: a Mobility Management Entity, MME, a Serving GPRS Support Node, SGSN, a Gateway GPRS Support Node, GGSN, or a Mobile Switching Centre, MSC, and the second network node 112 may be a base station.

The first network node 111 comprises a sending and receiving circuit 610 configured to send the message to or receive the message from the second network node 112. The message relates to the base station 120 serving the cell 125. The message comprises a part of a Cell Identity IE, relating to the cell 125. The part of the Cell Identity IE comprises two parts, a base station identity part for an identity of the base station 120, and a cell identity part for an identity of the cell 125.

One or more bits of the cell identity part are used for the base station identity part, such that the base station identity part is extended. The extended base station identity part is filled up with an extended identity of the base station 120.

The part of the Cell Identity IE may be comprised in a Global eNB ID Information Element of the message.

In some embodiments the message is to be sent to the second network node 112. In these embodiments, the first network node 111 may be configured to select an encoding choice value for the extended base station identity part among several encoding choices defined for the cell identity IE. The first network node 111 may be configured to select the encoding choice value by selecting a number of bits to be used for the base station identity.

In some embodiments, the message comprising the extended base station identity part is to be sent or received in any one out of: a configuration transfer procedure, and a S1 handover signalling procedure.

The extended base station identity part may comprise 1-7 bits of the cell identity part to be added to the base station identity part.

The base station identity part may comprise a base station identity of more than 20 bits, e.g. a base station identity of 21-27 bits.

The embodiments herein for sending or receiving a message to or from a second network node 112 may be implemented through one or more processors, such as a processor 620 in the first network node 111 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the in the first network node 111. One such carrier may be in the form of a CD ROM disc. It is however feasible with other data carriers such as a memory stick. The computer program code may furthermore be provided as pure program code on a server and downloaded to the first network node 111.

The network node 111 may further comprise a memory 630 comprising one or more memory units. The memory 630 is arranged to be used to store obtained information, store data, configurations, schedulings, and applications to perform the methods herein when being executed in the first network node 111.

Those skilled in the art will also appreciate that the sending and receiving circuit 610 described above may refer to a combination of analog and digital circuits, and/or one or more processors configured with software and/or firmware, e.g. stored in the memory 630, that when executed by the one or more processors such as the processor 620 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

1-22. (canceled)

23. A method in a first network node for sending a message to a second network node or receiving the message from the second network node, the method comprising:
sending the message to or receiving the message from the second network node, wherein the message relates to a base station serving a cell,
which message comprises a part of a Cell Identity Information Element (IE) relating to the cell, and where the Cell Identity IE comprises two parts, a base station identity part for an identity of the base station, and a cell identity part for an identity of the cell, and
wherein one or more bits of the cell identity part are used for the base station identity part, such that the base station identity part is extended, which extended base station identity part is filled up with an extended identity of the base station.

24. The method according to claim 23, wherein the part of the Cell Identity IE is comprised in a Global eNB ID Information Element of the message.

25. The method according to claim 23, wherein the message is sent to the second network node, and the method further comprises:
selecting an encoding choice value for the extended base station identity part, from among several encoding choices defined for the Cell Identity IE.

26. The method according to claim 25, wherein selecting the encoding choice value comprises selecting a number of bits to be used for the base station identity.

27. The method according to claim 23, wherein the message comprising the extended base station identity part is sent or received in any one of: a configuration transfer procedure, and a S1 handover signaling procedure.

28. The method according to claim 23, wherein the extended base station identity part comprises 1-7 bits of the cell identity part being added to the base station identity part.

29. The method according to claim 23, wherein the base station identity part comprises a base station identity of more than 20 bits.

30. The method according to claim 29, wherein the base station identity part comprises a base station identity of 21-27 bits.

31. The method according to claim 23, wherein the first network node is a base station and wherein the second network node is a base station.

32. The method according to claim 23, wherein the first network node is a base station, and wherein the second network node is any one of: a Mobility Management Entity (MME), a Serving GPRS Support Node (SGSN), a Gateway GPRS Support Node (GGSN), or a Mobile Switching Centre (MSC).

33. The method according to claim 23, wherein the first network node is any one out of: a Mobility Management Entity (MME), a Serving GPRS Support Node (SGSN), a Gateway GPRS Support Node (GGSN), or a Mobile Switching Centre (MSC), and wherein the second network node is a base station.

34. A first network node for sending a message to a second network node or receiving the message from the second network node, the first network node comprising:
a sending and receiving circuit configured to send the message to or receive the message from the second network node, wherein the message relates to a base station serving a cell,
which message comprises a part of a Cell Identity Information Element (IE) relating to the cell, and where the Cell Identity IE comprises two parts, a base station identity part for an identity of the base station, and a cell identity part for an identity of the cell, and
wherein one or more bits of the cell identity part is used for the base station identity part, such that the base station identity part is extended, which extended base station identity part is filled up with an extended identity of the base station.

35. The first network node according to claim 34, wherein the part of the Cell Identity (IE) is comprised in a Global eNB ID Information Element of the message.

36. The first network node according to claim 34, wherein the message is to be sent to the second network node, the first network node being configured to:
select an encoding choice value for the extended base station identity part, from among several encoding choices defined for the Cell Identity IE.

37. The first network node according to claim 36, wherein the first network node is configured to select the encoding choice value by selecting a number of bits to be used for the base station identity.

38. The first network node according to claim 34, wherein the message comprising the extended base station identity part, is to be sent or received in any one of: a configuration transfer procedure, and a S1 handover signaling procedure.

39. The first network node according to claim 34, wherein the extended base station identity part comprises 1-7 bits of the cell identity part to be added to the base station identity part.

40. The first network node according to claim 34, wherein the base station identity part comprises a base station identity of more than 20 bits.

41. The first network node according to claim 40, wherein the base station identity part comprises a base station identity of 21-27 bits.

42. The first network node according to claim 34, wherein the first network node is a base station and wherein the second network node is a base station.

43. The first network node according to claim 34, wherein the first network node is a base station, and wherein the second network node is any one out of: a Mobility Management Entity (MME), a Serving GPRS Support Node (SGSN), a Gateway GPRS Support Node (GGSN), or a Mobile Switching Centre (MSC).

44. The first network node according to claim 34, wherein the first network node is any one out of: a Mobility Management Entity (MME), a Serving GPRS Support Node (SGSN), a Gateway GPRS Support Node (GGSN), or a Mobile Switching Centre (MSC), and wherein the second network node is a base station.
